(19) United States
(12) Patent Application Publication
(10) Pub. No.: US 2025/0044117 A1
(43) Pub. Date: Feb. 6, 2025

(54) METHOD AND SYSTEM FOR PREDICTING CHANGES IN A STATIC ENVIRONMENT OF AN AUTOMATED VEHICLE WITH RESPECT TO A DIGITAL MAP

(71) Applicant: Robert Bosch GmbH, Stuttgart (DE)

(72) Inventor: Jan Rohde, Stuttgart (DE)

(21) Appl. No.: 18/775,429

(22) Filed: Jul. 17, 2024

(30) Foreign Application Priority Data
Aug. 1, 2023 (DE) 10 2023 207 322.6

(51) Int. Cl. G01C 21/00

(52) U.S. Cl. CPC G01C 21/3811; G01C 21/3837

(57) ABSTRACT

A method for predicting changes in a static environment of an automated vehicle with respect to a digital map. The digital map includes at least information about a road layout and static objects in the environment of the automated vehicle, comprises the following method steps. Deviations in the environment of the automated vehicle with respect to the digital map are identified on the basis of sensor data from at least one sensor and/or at least one database, and the identified deviations are quantified by ascertaining at least one change indicator. At least one probability of future changes in the environment of the automated vehicle with respect to the digital map is ascertained on the basis of the identified and quantified deviations.

### CROSS REFERENCE

The present application claims the benefit under 35 U.S.C. § 119 of German Patent Application No. DE 10 2023 207 322.6 filed on Aug. 1, 2023, which is expressly incorporated herein by reference in its entirety.

### FIELD

The present invention relates to a method and a system for predicting changes in a static environment of an automated vehicle with respect to a digital map.

### BACKGROUND INFORMATION

Reliable map attributes of digital maps for automated driving are specified by a set of safety-related requirements. The requirements include, for example, limit values for global and relative accuracies that must not be exceeded. A failure of a specific map attribute occurs if, for example, the accuracy requirement is exceeded without the digital map indicating this. An upper limit for the failure rate (for example, 1/5,000 km) is a further important safety requirement that is characteristic of digital maps. For the release of a digital map or a map attribute, proof of fulfillment of all safety requirements must be provided.

The failure rate of the map is also subject to changes over time. As soon as static infrastructure elements are changed, for example by renewing road markings or changing a speed limit by installing a corresponding road traffic sign, wherein road traffic signs are also included in the digital map, the failure rate of the digital map increases, since it becomes obsolete if no countermeasures are taken.

Static infrastructure elements have different change characteristics. For example, short-term changes can be effected, for example reduced or narrowed lanes due to an accident, which have no long-term impact on the failure rate of the digital map. There may also be immediate, long-term changes, for example a change in a speed limit sign, which lead to a direct increase in the failure rate of the map. In addition, slow and observable changes can occur. For example, the geometry of a road can be changed, which leads to a long-term increase in the map failure rate.

The characteristics of a map attribute or its type determine whether and which changes are possible. For example, changes to the road geometry may require extensive construction work. Therefore, a short-term change is not realistic. However, changes to a speed limit sign can be made in the short term. However, changes to traffic signs can also occur due to a long-term construction zone.

It is conventional in the related art to predict changes in a static environment with respect to a digital map. Predictions can refer to changes that are not yet recognizable, for example planned construction zones. However, current deviations can also be used to make predictions about future changes. In this case, the changes are not yet in effect, for example due to ongoing construction work, as a result of which predictions can be made. Changes that are already in effect can be detected in order to be used to control an automated vehicle.

### SUMMARY

One object of the present invention is to indicate or provide an improved method and an improved system for predicting changes in a static environment of an automated vehicle with respect to a digital map. This object may be achieved by a method and a system for predicting changes in a static environment of an automated vehicle with respect to a digital map, comprising features of the present invention. Advantageous example embodiments and developments of the present invention are disclosed herein.

According to an example embodiment of the present invention, a method for predicting changes in a static environment of an automated vehicle with respect to a digital map, wherein the digital map comprises at least information about a road layout and static objects in the environment of the automated vehicle, comprises the following method steps. Deviations in the environment of the automated vehicle with respect to the digital map are identified on the basis of sensor data from at least one sensor and/or at least one database, and the identified deviations are quantified by ascertaining at least one change indicator. At least one probability of future changes in the environment of the automated vehicle with respect to the digital map is ascertained on the basis of the identified and quantified deviations.

The automated vehicle is designed as a motor vehicle and can be guided in an at least partially automated manner. The wording “at least partially automated guidance” comprises one or more of the following cases: assisted guidance, partially automated guidance, highly automated guidance, fully automated guidance.

Assisted guidance means that a driver of the motor vehicle continuously carries out either lateral or longitudinal guidance of the motor vehicle. The relevant other driving task (i.e. control of the longitudinal or lateral guidance of the motor vehicle) is carried out automatically. This means that, with assisted guidance of the motor vehicle, either the lateral or the longitudinal guidance is controlled automatically.

Partially automated guidance means that in a specific situation (for example: driving on a freeway, driving within a parking lot, overtaking an object, driving within a lane defined by lane markings) and/or for a certain period of time, longitudinal and a lateral guidance of the motor vehicle are automatically controlled. A driver of the vehicle does not have to manually control the longitudinal and lateral guidance of the motor vehicle. However, the driver must continuously monitor the automatic control of the longitudinal and lateral guidance in order to be able to intervene manually if necessary. The driver must be prepared to fully take over the motor vehicle at any time.

Highly automated guidance means that for a certain period of time in a specific situation (for example: driving on a freeway, driving within a parking lot, overtaking an object, driving within a lane defined by lane markings), longitudinal and a lateral guidance of the motor vehicle are automatically controlled. A driver of the vehicle does not have to manually control the longitudinal and lateral guidance of the motor vehicle. The driver does not have to continuously monitor the automatic control of the longitudinal and lateral guidance in order to be able to intervene manually if necessary. If required, a prompt to take over the control of the longitudinal and lateral guidance is automatically output to the driver, in particular output with a sufficient time reserve. The driver therefore potentially has to be able to take over the control of the longitudinal and lateral guidance. Limitations of the automatic control of the lateral and longitudinal guidance are automatically detected. In highly automated guidance, it is not possible to bring about a state of minimal risk automatically in every starting situation.

Fully automated guidance means that in a specific situation (for example: driving on a freeway, driving within a parking lot, overtaking an object, driving within a lane defined by lane markings), longitudinal and a lateral guidance of the motor vehicle are automatically controlled. A driver of the vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is terminated, the driver is automatically prompted to take over the driving task (controlling the lateral and longitudinal guidance of the motor vehicle), in particular with a sufficient time reserve. If the driver does not take over the driving task, a return to a state of minimal risk is automatically made. Limitations of the automatic control of the lateral and longitudinal guidance are automatically detected. In all situations, it is possible to return to a system state of minimal risk automatically.

All information stored in the digital map can generally be referred to as attributes. All changes to static objects and road layouts with respect to the digital map are to be referred to as deviations in the static environment of the automated vehicle with respect to the digital map. These may only be temporary, which is why it is not necessarily necessary to update the digital map if there is a deviation. For example, it may be that a road surface has been renewed, which is why a short-term deviation from a road layout stored in the digital map can be determined. However, this deviation is only temporary and will not become permanent once the work on the road has been completed. A change, on the other hand, is to be understood to mean changes that are expected to be permanent, such as changes to the road layout. Such a change requires an adjustment or update of the digital map, since the digital map will have at least one segment that does not correctly represent part of the environment in the future.

The method according to the present invent advantageously enables a prediction of changes in the static environment, which would otherwise, for example in the case of a pure detection of changes that are already in effect, lead to an outdated digital map and thus to an increased failure rate of the digital map. This aspect is particularly important in the context of safety-relevant applications in order to remain below a defined failure rate or error rate that is required for the safe use of the digital map in a safety-relevant function as part of the automated control of the vehicle. The method thus contributes to a safety concept in the framework of which reliable map attributes can be provided. Thus, road safety when controlling the automated vehicle can be improved.

According to the present invention, by reducing the degradation (i.e., the increase in the failure rate) of the digital map during operation, an error rate budget for creating or updating the digital map can also be advantageously reduced. This is expected to have a positive impact on map production costs.

The sensor data based on which the deviations are identified can, for example, be video data from at least one camera of the automated vehicle and/or at least one external camera, i.e. a camera of a further automated vehicle and/or a camera located in the region of a piece of infrastructure. For example, conventional safety-qualified video-based perception approaches can be used to detect some static environmental features, for example some lane marking types. Alternatively or additionally, the sensor data can be radar data from a radar unit of the automated vehicle or an external radar unit, data from a lidar unit or an external lidar unit, odometry data from the automated vehicle and/or at least one further vehicle and data from a navigation system. Furthermore, satellite data and/or aerial photographs can alternatively or additionally be used as sensor data.

According to an example embodiment of the present invention, in addition to sensor data, information can also be obtained from databases in order to identify deviations in the static environment of the automated vehicle. For example, construction site databases that contain information about ongoing and/or planned construction sites can be used. Alternatively or additionally, at least one database containing information about a traffic flow can also be used.

Thus, the present method for predicting changes in a static environment of an automated vehicle with respect to a digital map uses the aforementioned information or data and supplements it with the at least one change indicator in order to predict changes in the digital maps. As a result, the costs for change prediction information from external providers (for example, traffic flow information) can be significantly reduced. The use of the at least one change indicator offers the advantage that more reliable predictions can be made compared with a prediction without using a change indicator. The method is particularly suitable for map attributes whose changes are effected slowly and are observable, for example changes to the road geometry, or the construction of a toll station.

In one example embodiment of the present invention, a similarity metric is ascertained with regard to information stored in the digital map and the identified deviations, as a change indicator. A variety of similarity metrics are available that can be used to determine a similarity between the sensor data and/or information from a database and map attributes of the digital map, for example, a Hausdorff metric can be ascertained as a similarity indicator.

In one example embodiment of the present invention, the at least one similarity indicator is ascertained in a cloud-based or vehicle-internal manner. The cloud-based approach has the advantage of ensuring that the same similarity indicator is evaluated for all available data. The vehicle-internal approach can be used, for example, if strict bandwidth limitations apply to data exchange with the automated vehicle and, for example, no sensor data can be sent to a vehicle-external cloud system.

In one example embodiment of the present invention, a development over time of the at least one similarity indicator is taken into account when ascertaining the at least one probability of future changes in the environment of the automated vehicle with respect to the digital map. For this purpose, similarity indicators must be stored in a memory. A development over time can be used as an indication of possible upcoming changes. For example, a similarity indicator can change in a previously unobserved way if a new construction site is built.

In one example embodiment of the present invention, the at least one change indicator comprises information about changes in the sensor data. For example, the change indicator can comprise information about a reduction in quality and/or disturbances in the sensor data. Advantageously, the degradation of a sensor can be taken into account when predicting changes.

In one example embodiment of the present invention, the probability of future changes in the environment of the automated vehicle with respect to the digital map is ascertained by means of a machine learning algorithm or a rule-based algorithm. That is to say, information about the deviations and change indicators is used as input data for the algorithm. The rule-based approach can also be referred to as a classic approach. The rule-based algorithm is trained by means of a set of rules. These rules can, for example, be provided in the form of expert knowledge from a database or by another algorithm. Advantageously, the approach of the rule-based algorithm can be implemented particularly simply, as a result of which the process can be carried out in a resource-efficient manner.

In one example embodiment of the present invention, the machine learning algorithm is trained on the basis of information about previous deviations, already ascertained change indicators, previous changes and already ascertained probabilities of the previous changes. Conventional machine learning algorithms or rule-based algorithms can be used to ascertain at least one probability. However, training data other than those mentioned can also be used. For example, information about previous deviations, already ascertained change indicators, previous changes and already ascertained probabilities of previous changes with regard to another automated vehicle or a fleet of automated vehicles can be used for training. The advantage of this approach is that even complex correlations and dependencies between different prediction sources are recognized and taken into account in the prediction.

In one example embodiment of the present invention, the method comprises the following additional method steps. The at least one ascertained probability of future changes in the environment of the automated vehicle with respect to the digital map is compared with at least one predeterminable threshold value. At least one segment of the digital map is deactivated or updated if the ascertained probability is greater than the threshold value. By deactivating or updating the at least one segment of the digital map, an error rate of the digital map can advantageously be reduced.

In one example embodiment of the present invention, the method comprises the following additional method step. An electronic horizon is provided for the automated vehicle based on the digital map comprising the at least one deactivated or updated segment. Advantageously, the method can provide an error-free electronic horizon, since sections of the digital map that no longer correctly represent the static environment due to changes are not used to generate the electronic horizon, or updated segments of the digital map are used to generate the electronic horizon. To provide the electronic horizon, a position and orientation of the automated vehicle in relation to the digital map must be known or ascertained. For example, conventional map-matching methods can be used for this purpose.

According to an example embodiment of the present invention, a system for predicting changes in a static environment of an automated vehicle with respect to a digital map, wherein the digital map comprises at least information about a road layout and static objects in the environment of the automated vehicle, has a detection device with at least one sensor for identifying deviations in an environment of the automated vehicle with respect to the digital map, an evaluation device for quantifying identified deviations by ascertaining at least one change indicator, and a prediction device for ascertaining a probability of future changes in the environment of the automated vehicle with respect to the digital map on the basis of the identified and quantified deviations.

In one example embodiment of the present invention, the system has a memory for storing information about previous deviations, already ascertained change indicators, previous changes and already ascertained probabilities of the previous changes. As a result, the machine learning algorithm can be trained more advantageously.

In one example embodiment of the present invention, the system has a processing device for comparing the ascertained probability of future changes in the environment of the automated vehicle with respect to the digital map with a predeterminable threshold value. As a result, the at least one segment of the digital map that inaccurately represents the static environment of the automated vehicle can be deactivated or updated. In this case, it is possible that at least one segment is deactivated and at least one further segment is updated.

In one example embodiment of the present invention, the system has a localization device for determining a position and an orientation of the automated vehicle and a horizon generator for generating an electronic horizon for the automated vehicle on the basis of the digital map. In particular, the electronic horizon can be provided on the basis of the digital map comprising the at least one deactivated or updated segment.

The method and the system for predicting changes in a static environment of an automated vehicle with respect to a digital map are explained in more detail below based on schematic figures.

### BRIEF DESCRIPTION OF EXAMPLE EMBODIMENTS

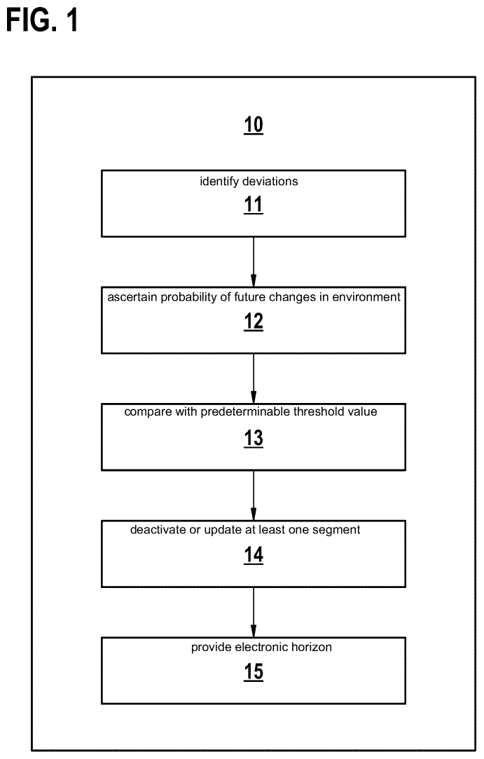

FIG. 1 shows method steps of a method for predicting changes in a static environment of an automated vehicle with respect to a digital map, according to an example embodiment of the present invention.

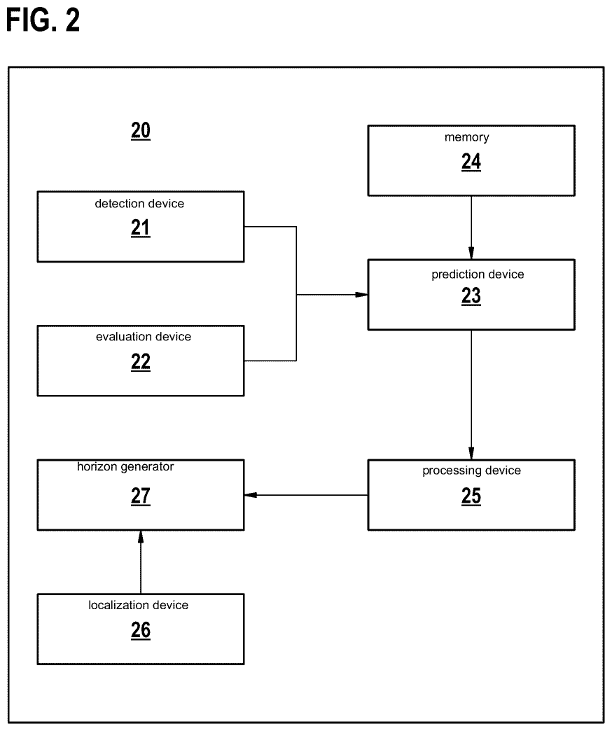

FIG. 2 shows elements of a system for predicting changes in a static environment of an automated vehicle with respect to a digital map, according to an example embodiment of the present invention.

### DETAILED DESCRIPTION OF EXAMPLE EMBODIMENTS

FIG. 1 schematically shows method steps 11, 12, 13, 14, 15 of a method 10 for predicting changes in a static environment of an automated vehicle with respect to a digital map.

Automated vehicles are highly dependent on map-based information in order to support them in route planning, perception and situational understanding. In addition to increased accuracy, the digital map must also be very up-to-date, i.e. it must have a high degree of temporal and spatial precision.

The digital map comprises at least information about a road layout and static objects in the environment of the automated vehicle. The digital map can also comprise further information. In particular, the digital map can have logical layers with information from different categories.

For example, the digital map can have a planning layer. The planning layer contains, for example, information about how the exact lane geometries are designed, topography information and connectivity information. The planning layer is used in order to keep the automated vehicle in a lane through maneuver planning. Some static environmental objects can be included in a safety-qualified planning layer.

The digital map can also have a localization layer. The localization layer contains detectable objects for different sensor types, for example, the localization layer can comprise video and/or radar and/or lidar data, which can be stored separately in the localization layer. Current sensor information can be compared with information from the localization layer having the destination in order to estimate a vehicle position.

The digital map can also have a dynamic layer. The dynamic layer contains dynamically changing information such as road conditions, traffic flow, weather conditions and/or parking information. The dynamic layer is typically used for comfort functions in particular.

In a first method step 11 of the method 10, deviations in the environment of the automated vehicle with respect to the digital map are identified on the basis of sensor data from at least one sensor and/or at least one database, and the identified deviations are quantified by ascertaining at least one change indicator.

For example, a similarity metric, such as a Hausdorff metric, can be ascertained with regard to the information stored in the digital map and the identified deviations, as a change indicator. This can be either cloud-based or vehicle-internal. The at least one change indicator can alternatively or additionally also comprise information about changes to the sensor data.

In a second method step 12, at least one probability of future changes in the environment of the automated vehicle with respect to the digital map is ascertained on the basis of the identified and quantified deviations. A development over time of the at least one similarity indicator can be taken into account in this case.

The probability of future changes in the environment of the automated vehicle with respect to the digital map can, for example, be ascertained by means of a machine learning algorithm or a rule-based algorithm, wherein the machine learning algorithm can be trained on the basis of information about previous deviations, previously ascertained change indicators, previous changes and previously ascertained probabilities of the previous changes prior to the method 10.

In an optional third method step 13, the at least one ascertained probability of future changes in the environment of the automated vehicle with respect to the digital map can be compared with at least one predeterminable threshold value. If the ascertained probability is greater than the threshold value, at least one segment of the digital map can be deactivated or updated in an optional fourth method step 14. Deactivating the at least one segment of the digital map is to be understood to mean that the relevant segment of the digital map is no longer used for automatic control of the automated vehicle.

In a fifth method step 15, which is also optional, an electronic horizon is provided for the automated vehicle based on the digital map comprising the at least one deactivated or updated segment. The third, fourth and fifth method steps 13, 14, 15 can also be omitted.

FIG. 2 schematically shows elements 21, 22, 23, 24, 25, 26, 27 of a system 20 for predicting changes in the static environment of the automated vehicle with respect to the digital map.

The system 20 has a detection device 21 with at least one sensor for identifying deviations in the environment of the automated vehicle with respect to the digital map. The detection device 21 of the system can have at least one vehicle-internal sensor and/or at least one vehicle-external sensor. Thus, the detection device 21 is not limited to the automated vehicle. A vehicle-external sensor can, for example, be designed as an infrastructure sensor that is arranged in a fixed position in the region of a piece of infrastructure. However, the vehicle-external sensor can also be a sensor of a further vehicle, in particular a further automated vehicle.

The system 20 also has an evaluation device 22 for quantifying identified deviations by ascertaining at least one change indicator. The detection device 21 and the evaluation device 22 are connected to a prediction device 23 of the system 20 and are designed to provide identified deviations and ascertained similarity indicators to the prediction device 23. The prediction device 23 is designed to ascertain the probability of future changes in the environment of the automated vehicle with respect to the digital map on the basis of the identified and quantified deviations. This can be effected by means of a machine learning algorithm or a rule-based algorithm, for example.

The system 20 optionally has a memory 24. The memory 24 is provided for storing information about previous deviations, previously ascertained change indicators, previous changes and previously ascertained probabilities of previous changes. The memory is connected to the prediction device 23. Information stored in the memory 24 can be used by the prediction device 23 in order to train the machine learning algorithm if it is used for prediction. As part of such training, parameters are ascertained which can be provided to the prediction device 23 in order to take them into account in the prediction.

Optionally, the system 20 has a processing device 25 for comparing the ascertained probability of future changes in the environment of the automated vehicle with respect to the digital map with a predeterminable threshold value. In this way, a reliable prediction of changes in the static environment can be made.

In order to provide an electronic horizon for the automated vehicle, the system 20 can additionally comprise a localization device 26 for determining a position and an orientation of the automated vehicle, and a horizon generator 27 for generating an electronic horizon for the automated vehicle on the basis of the digital map comprising the at least one deactivated or updated segment. For this purpose, the horizon generator 27 is connected to the localization device 26 and processing device 25 in order to be able to receive information about the position and orientation of the automated vehicle in relation to the digital map and information about deactivated and/or updated segments of the digital map. However, the localization device 26 and the horizon generator 27 can be omitted, as can the memory 24.

What is claimed is:

1. A method for predicting changes in a static environment of an automated vehicle with respect to a digital map, wherein the digital map includes at least information about a road layout and static objects in the environment of the automated vehicle, the method comprising the following steps:
identifying deviations in the environment of the automated vehicle with respect to the digital map based on sensor data from at least one sensor and/or at least one database, and quantifying the identified deviations by ascertaining at least one change indicator; and
ascertaining at least one probability of future changes in the environment of the automated vehicle with respect to the digital map based on the identified and quantified deviations.

2. The method according to claim 1, wherein, as a change indicator of the at least one change indicator, a similarity metric is ascertained with regard to information stored in the digital map and the identified deviations.

3. The method according to claim 1, wherein the at least one similarity indicator is ascertained in a cloud-based or vehicle-internal manner.

4. The method according to claim 1, wherein a development over time of the at least one similarity indicator is taken into account when ascertaining the at least one probability of future changes in the environment of the automated vehicle with respect to the digital map.

5. The method according to claim 1, wherein the at least one change indicator includes information about changes in the sensor data.

6. The method according to claim 1, wherein the probability of future changes in the environment of the automated vehicle with respect to the digital map is ascertained using a machine learning algorithm or a rule-based algorithm.

7. The method according to claim 6, wherein the machine learning algorithm is trained based on information about previous deviations, already ascertained change indicators, previous changes and already ascertained probabilities of the previous changes.

8. The method according to claim 1, further comprising the following steps:
comparing the at least one ascertained probability of future changes in the environment of the automated vehicle with respect to the digital map with at least one predeterminable threshold value; and
deactivating or updating at least one segment of the digital map when the ascertained probability is greater than the threshold value.

9. The method according to claim 8, further comprising:
providing an electronic horizon for the automated vehicle based on the digital map including the at least one deactivated or updated segment.

10. A system configured to predict changes in a static environment of an automated vehicle with respect to a digital map, wherein the digital map includes at least information about a road layout and static objects in the environment of the automated vehicle, the system comprising:
a detection device including at least one sensor configured to identify deviations in an environment of the automated vehicle with respect to the digital map;
an evaluation device configured to quantify identified deviations by ascertaining at least one change indicator; and
a prediction device configured to ascertain a probability of future changes in the environment of the automated vehicle with respect to the digital map based on the identified and quantified deviations.

11. The system according to claim 10, further comprising:
a memory storing information about previous deviations, already ascertained change indicators, previous changes and already ascertained probabilities of the previous changes.

12. The system according to claim 10, further comprising:
a processing device configured to compare the ascertained probability of future changes in the environment of the automated vehicle with respect to the digital map with a predeterminable threshold value.

13. The system according to claim 10, further comprising:
a localization device configured to determine a position and an orientation of the automated vehicle; and
a horizon generator configured to generate an electronic horizon for the automated vehicle based on the digital map.
